(19) United States
(12) Patent Application Publication
(10) Pub. No.: US 2024/0254264 A1
(43) Pub. Date: Aug. 1, 2024

(54) PROCESS FOR PREPARING AN OLEFIN POLYMER COMPRISING WITHDRAWING A GASEOUS SAMPLE FOR ANALYZING

(71) Applicant: Basell Polyolefine GmbH, Wesseling (DE)

(72) Inventors: Gerhardus Meier, Frankfurt/M (DE); Ulf Schueller, Weiterstadt (DE); Heike Gregorius, Koblenz (DE); Gregor Hahn, Wiesbaden (DE)

(73) Assignee: Basell Polyolefine GmbH, Wesseling (DE)

(21) Appl. No.: 18/561,455

(22) PCT Filed: May 17, 2022
(86) PCT No.: PCT/EP2022/063256

§ 371 Date: Nov. 16, 2023

(30) Foreign Application Priority Data
May 18, 2021 (EP) 21174311.7

(51) Int. Cl. C08F 210/16; C08F 2/01; C08F 2/34; C08F 4/642

(52) U.S. Cl. CPC C08F 210/16; C08F 2/01; C08F 2/34; C08F 4/6421; C08F 2400/02

(57) ABSTRACT

A process for preparing an olefin polymer in a polymerization apparatus in the presence of a solid particulate polymerization catalyst and an organometallic compound, including the steps of withdrawing a gaseous stream from the polymerization apparatus, passing the gaseous stream through a bed of particulate solid having, at the surface of the particulate solid, chemical groups which are reactive with the organometallic compound, and feeding a sample of the gaseous stream into an analyzer.

### FIELD OF THE INVENTION

In general, the present disclosure relates to the field of chemistry. More specifically, the present disclosure relates to polymer chemistry. In particular, the present disclosure relates to a process for preparing an olefin polymer, wherein a gaseous sample is withdrawn from a polymerization apparatus and fed to an analyzer.

### BACKGROUND OF THE INVENTION

In some instances, processes for producing polyolefins include suspension and gas-phase polymerization processes in the presence of a solid polymerization catalyst and an organometallic compound as cocatalyst and/or as scavenger. In some instances, suspension polymerization processes are carried out in stirred tank reactors or loop reactors. In some instances, gas-phase polymerizations are carried out in fluidized-bed reactors, stirred gas-phase reactors, or multizone circulating reactors with two distinct interconnected gas-phase polymerization zones.

Information regarding the composition of the reaction mixture is useful for controlling the polymerization reaction. In some instances, a gaseous sample is withdrawn from the polymerization reactor or a piece of equipment of the polymerization apparatus, where a gaseous phase is present. The composition of the gaseous sample is analyzed. In some instances, the analysis occurs by a gas chromatograph, a mass spectrometer, or a Raman probe.

In some instances and to improve the quality of the gas analytics and prolong the lifetime of the analytical equipment, the gaseous sample is passed through a filter and then fed to the analyzer. Nonetheless, analysis of the gas samples may yield unreliable results, thereby leading to recalibration of the analyzer and cleaning of the sample dosing equipment.

### SUMMARY OF THE INVENTION

In a general embodiment, the present disclosure provides a process for preparing an olefin polymer including the steps of
a) feeding
   (i) a solid particulate polymerization catalyst,
   (ii) an organometallic compound, and
   (iii) an olefin or a combination of an olefin and one or more other olefins into a polymerization apparatus having a polymerization reactor or a combination of polymerization reactors,
b) homopolymerizing the olefin or copolymerizing the olefin and the one or more other olefins at temperatures from 20° C. to 200° C. and pressures of from 0.1 MPa to 20 MPa, in the presence of the polymerization catalyst and the organometallic compound,
c) withdrawing a gaseous stream from the polymerization apparatus,
d) passing the gaseous stream through a bed of particulate solid, having, at the surface of the particulate solid, chemical groups which are reactive with the organometallic compound, and
e) feeding a sample of the gaseous stream into an analyzer for analyzing the gaseous sample.

In some embodiments, the analyzer is a gas chromatograph.

In some embodiments, the organometallic compound is an aluminum alkyl.

In some embodiments, the particulate solid is an oxide or a mixed oxide of an element selected from the group consisting of calcium, aluminum, silicon, magnesium, and titanium. In some embodiments, the particulate solid is ZrO₂ or B₂O₃.

In some embodiments, the chemical groups at the surface of the particulate solid which are reactive with the organometallic compound are selected from the group consisting of OH groups, adsorbed water, and strained Si—O—Si bridges.

In some embodiments, the particulate solid is a silica gel equipped with a humidity indicator.

In some embodiments, the gaseous stream withdrawn from the polymerization apparatus is a continuous gas stream which is withdrawn from the polymerization apparatus at a flow rate of from 1 Nl/h to 500 Nl/h.

In some embodiments, the analyzer is provided with the sample of the gaseous stream at intervals.

In some embodiments, two or more gaseous streams are withdrawn from the polymerization apparatus at different positions. In some embodiments, samples of one or more the gaseous streams are fed to an analyzer, alternatively an analyzer dedicated to each gaseous stream.

In some embodiments, the bed of particulate solid is contained in a vessel having a volume of from 50 cm³ to 10 000 cm³.

In some embodiments, the bed of particulate solid is contained in a vessel having a pipe having a diameter from 6 mm to 100 mm, an inlet for introducing a gas stream into the pipe, and an outlet for withdrawing a gas stream from the pipe, wherein the distance between the inlet and the outlet is from 0.2 m to 10 m.

In some embodiments, the vessel further includes a first valve at a first end of the pipe for introducing the bed of particulate solid into the pipe and a second valve at the opposing, second end of the pipe for removing the bed of particulate solid from the pipe, or the inlet and the outlet of the pipe are provided with screens having a mesh size from 35 μm to 2 mm for retaining the bed of particulate solid within the pipe.

In some embodiments, the results obtained by the analysis of the gaseous samples are fed as measurement signals to a controller for controlling the process for preparing the olefin polymer.

In some embodiments, the present disclosure provides a vessel having a pipe having a diameter from 6 mm to 100 mm, an inlet for introducing a gas stream into the pipe, an outlet for withdrawing a gas stream from the pipe, a first valve at a first end of the pipe for introducing a bed of particulate solid into the pipe, and a second valve at the opposing, second end of the pipe for removing the bed of particulate solid from the pipe, wherein the inlet and the outlet of the pipe are provided with screens having a mesh size from 35 μm to 2 mm for retaining the bed of particulate solid within the pipe and the distance between the inlet and the outlet is from 0.2 m to 10 m.

In some embodiments, the present disclosure provides a method for controlling an olefin polymerization process for homopolymerizing an olefin or copolymerizing an olefin and one or more other olefins at temperatures from 20 to 200° C. and pressures of from 0.1 MPa to 20 MPa, in the presence of a solid particulate polymerization catalyst and an organometallic compound in a polymerization apparatus including a polymerization reactor or a combination of polymerization reactors, including the steps of,
withdrawing a gaseous stream from the polymerization apparatus;
passing the gaseous stream through a bed of particulate solid having, at the surface of the particulate solid, chemical groups which are reactive with the organometallic compound;
feeding a sample of the gaseous stream into an analyzer for analyzing the gaseous sample;
analyzing the sample, thereby obtaining information on the conditions within the polymerization apparatus; and
adapting, based on the information, the polymerization conditions within the polymerization apparatus to predefined values.

### BRIEF DESCRIPTION OF THE DRAWINGS

FIG. 1 shows a schematic of a polymerization apparatus including a series of polymerization reactors.

FIG. 2 shows a schematic of a vessel for containing a bed of particulate solid.

### DETAILED DESCRIPTION OF THE INVENTION

In some embodiments, the present disclosure provides a process for preparing an olefin polymer. In some embodiments, the olefins for preparing the olefin polymer are 1-olefins. As used herein, the term “1-olefins” refers to hydrocarbons having terminal double bonds, without being restricted thereto. In some embodiments, the olefins are nonpolar olefinic compounds. In some embodiments, the 1-olefins are linear C₂-C₁₂-1-alkenes, branched C₂-C₁₂-1-alkenes, conjugated dienes, or nonconjugated dienes. In some embodiments, the linear alkenes are C₂-C₁₀-1-alkenes. In some embodiments, the linear C₂-C₁₀-1-alkenes are selected from the group consisting of ethylene, propylene, 1-butene, 1-pentene, 1-hexene, 1-heptene, 1-octene, and 1-decene. In some embodiments, the branched alkenes are C₂-C₁₀-1-alkenes. In some embodiments, the branched C₂-C₁₀-1-alkene is 4-methyl-1-pentene. In some embodiments, the dienes are selected from the group consisting of 1,3-butadiene, 1,4-hexadiene, and 1,7-octadiene. In some embodiments, mixtures of various 1-olefins are polymerized. In some embodiments, the olefins have the double bond as part of a cyclic structure. In some embodiments, the cyclic structure has one or more ring systems. In some embodiments, the olefins, including a cyclic structure, are selected from the group consisting of cyclopentene, norbornene, tetracyclododecene, methylnorbornene, 5-ethylidene-2-norbornene, norbornadiene, and ethylnorbornadiene. In some embodiments, mixtures of two or more olefins are polymerized. In some embodiments, the mixtures are made from or containing two, three, or four olefins.

In some embodiments, the olefin polymer is obtained by homopolymerizing an olefin or by copolymerizing an olefin and one or more other olefins. In some embodiments, the olefin polymer is obtained by homopolymerizing or copolymerizing ethylene or propylene, alternatively by homopolymerizing or copolymerizing ethylene. In some embodiments, comonomers in propylene polymerization are up to 60 wt. % of ethylene, 1-butene, or 1-hexene, alternatively from 0.5 wt. % to 35 wt. % of ethylene, 1-butene, or 1-hexene. In some embodiments, comonomers in ethylene polymerization are up to 20 wt. %, alternatively from 0.01 wt. % to 15 wt. %, alternatively from 0.05 wt. % to 12 wt. %, of C₃-C₈-1-alkenes. In some embodiments, the alkene is selected from the group consisting of 1-butene, 1-pentene, 1-hexene, and 1-octene. In some embodiments, ethylene is copolymerized with from 0.1 wt. % to 12 wt. % of 1-hexene or 1-butene.

In some embodiments, the homopolymerization of an olefin or the copolymerization an olefin and one or more other olefins is carried out at temperatures in the range from 20° C. to 200° C., alternatively from 30° C. to 150° C., alternatively from 40° C. to 130° C., and pressures from 0.1 MPa to 20 MPa, alternatively from 0.3 MPa to 5 MPa, in the presence of a solid particulate polymerization catalyst and an organometallic compound, which are fed, together with the olefin or the combination of an olefin and one or more other olefins, into a polymerization apparatus having a polymerization reactor or a combination of polymerization reactors.

In some embodiments, the polymerization is carried out using Phillips catalysts based on chromium oxide, using Ziegler- or Ziegler-Natta-catalysts, or using single-site catalysts. As used herein, single-site catalysts are catalysts based on chemically uniform transition metal coordination compounds. In some embodiments, mixtures of two or more of these catalysts are used for the polymerization of olefins. In some embodiments, mixed catalysts are referred to as hybrid catalysts.

In some embodiments, the catalysts are of the Ziegler or Ziegler-Natta type. In some embodiments, the catalysts are of the Ziegler or Ziegler-Natta type are made from or containing a compound of titanium or vanadium, a compound of magnesium and optionally an electron donor compound and/or a particulate inorganic oxide as a support material. In some embodiments, the titanium compounds are made of the halides or alkoxides of trivalent or tetravalent titanium. In some embodiments, the titanium compounds are titanium alkoxy halogen compounds or mixtures of various titanium compounds. In some embodiments, the titanium compounds are made from or containing chlorine as the halogen. In some embodiments, at least one compound of magnesium is used in the production of the solid component. In some embodiments, the magnesium compounds are halogen-comprising magnesium compounds, alternatively magnesium halides. In some embodiments, the halogens are chlorides or bromides. In some embodiments, the magnesium halides are obtained by reaction with halogenating agents. In some embodiments, the magnesium compounds are selected from the group consisting of magnesium dichloride, magnesium dibromide, and di(C₁-C₁₀-alkyl)magnesium compounds. In some embodiments, electron donor compounds for preparing Ziegler or Ziegler-Natta type catalysts are selected from the group consisting of alcohols, glycols, esters, ketones, amines, amides, nitriles, alkoxysilanes, and aliphatic ethers. In some embodiments, the electron donor compounds are used alone or in mixtures with each other or additional electron donor compounds. In some embodiments, electron donor compounds are selected from the group consisting of amides, esters, and alkoxysilanes.

In some embodiments, the catalysts are Phillips-type chromium catalysts. In some embodiments, the Phillips-type chromium catalysts are prepared by applying a chromium compound to an inorganic support and subsequently activating the obtained catalyst precursor at temperatures in the range from 350 to 1000° C., thereby converting chromium present in valences lower than six into the hexavalent state. In some embodiments, an element other than chromium is used and selected from the group consisting of magnesium, calcium, boron, aluminum, phosphorus, titanium, vanadium, zirconium, and zinc. In some embodiments, the element is selected from the group consisting of titanium, zirconium, and zinc. In some embodiments, the elements are used in combinations. In some embodiments, the catalyst precursor is doped with fluoride prior to or during activation. In some embodiments, supports for Phillips-type catalysts are made from or containing aluminum oxide, silicon dioxide, titanium dioxide, zirconium dioxide, mixed oxides thereof, or cogels thereof. In some embodiments, the silicon dioxide is in form of silica gel. In some embodiments, supports for Phillips-type catalysts are made from or containing aluminum phosphate. In some embodiments, support materials are obtained by modifying the pore surface area. In some embodiments, the pore surface area is modified using compounds of the elements boron, aluminum, silicon, or phosphorus. In some embodiments, the pore surface area is modified using a silica gel. In some embodiments, the pore surface area is modified using spherical or granular silica gels. In some embodiments, the spherical silica gels are spray dried. In some embodiments, the activated chromium catalysts are subsequently prepolymerized or prereduced. In some embodiments, the prereduction is carried out with cobalt or hydrogen at 250° C. to 500° C., alternatively at 300° C. to 400° C., in an activator.

In some embodiments, the catalysts are supported single-site catalysts. In some embodiments, the supported single-site catalysts are made from or containing bulky sigma- or pi-bonded organic ligands. In some embodiments, the catalysts are based on mono-Cp complexes. In some embodiments, the catalysts are based on bis-Cp complexes, which are herein referred to as metallocene catalysts. In some embodiments, the catalysts based on late transition metal complexes, alternatively iron-bisimine complexes. In some embodiments, the catalysts are mixtures of two or more single-site catalysts or mixtures of different types of catalysts made from or containing at least one single-site catalyst.

In some embodiments, the solid particulate polymerization catalysts are used in combination with an organometallic compound. In some embodiments, the organometallic compounds are organometallic compounds of metals of Groups 1, 2, 12, 13 or 14 of the Periodic Table of Elements, alternatively organometallic compounds of metals of Group 13, alternatively organoaluminum compounds. In some embodiments, the organometallic compounds are organometallic alkyls, organometallic alkoxides, or organometallic halides.

In some embodiments, the organometallic compounds are cocatalysts for the solid particulate polymerization catalysts and scavengers which react with polar compounds.

In some embodiments, the organometallic compounds are selected from the group consisting of lithium alkyls, magnesium alkyls, zinc alkyls, magnesium alkyl halides, aluminum alkyls, silicon alkyls, silicon alkoxides, and silicon alkyl halides. In some embodiments, the organometallic compounds are aluminum alkyls or magnesium alkyls. In some embodiments, the organometallic compounds are aluminum alkyls, alternatively trialkylaluminum compounds or compounds of this type in which an alkyl group is replaced by a halogen atom. In some embodiments, the halogen atom is chlorine or bromine. In some embodiments, the aluminum alkyls are selected from the group consisting of trimethylaluminum, triethylaluminum, triisobutylaluminum, tri-n-hexylaluminum, diethylaluminum chloride, and mixtures thereof.

In some embodiments, the process is carried out using low-pressure polymerization. In some embodiments, the polymerization reactors are stirred tank reactors or loop reactors. In some embodiments, the polymerization reactors are fluidized-bed reactors, stirred gas-phase reactors, or multizone circulating reactors with two distinct interconnected gas-phase polymerization zones. In some embodiments, the polymerization is carried out batchwise or continuously in one or more stages, alternatively in one, two, three, or four stages. In some embodiments, the process is selected from the group consisting of solution processes, suspension processes, and gas-phase processes. In some embodiments, the polymerization is gas-phase polymerization or suspension polymerization. In some embodiments, the gas-phase polymerization is carried out in gas-phase fluidized-bed reactors or multizone circulating reactors. In some embodiments, the suspension polymerization is carried out in loop reactors or stirred tank reactors.

In some embodiments, the polymerization process is a suspension polymerization in a suspension medium or the monomers. In some embodiments, the suspension medium is an inert hydrocarbon or mixtures of hydrocarbons. In some embodiments, inert hydrocarbon is selected from the group consisting of isobutane. In some embodiments, the polymerization temperatures are in the range from 20° C. to 115° C., and the pressure is in the range of from 0.1 MPa to 10 MPa. In some embodiments, the solids content of the suspension is in the range of from 10 wt. % to 80 wt. %. In some embodiments, the polymerization is carried out both batchwise or continuously. In some embodiments, the batchwise polymerization occurs in stirred autoclaves. In some embodiments, continuous polymerization occurs in tubular reactors, alternatively in loop reactors. In some embodiments, the polymerization is carried out by the Phillips PF process as described in U.S. Pat. Nos. 3,242,150 and 3,248,179.

In some embodiments, the suspension medium is inert. In some embodiments, the suspension medium is a liquid or supercritical fluid under the reaction conditions. In some embodiments, the suspension medium has a boiling point which differs from the boiling points of the monomers and comonomers, thereby permitting recovery of suspension medium from the product mixture by distillation. In some embodiments, the suspension media are saturated hydrocarbons having from 4 to 12 carbon atoms. In some embodiments, the saturated hydrocarbons are selected from the group consisting of isobutane, butane, propane, isopentane, pentane, hexane, and mixtures thereof. In some embodiments, the saturated hydrocarbons are diesel oil.

In some embodiments, the suspension polymerization takes place in a series of two, alternatively three or four, stirred vessels. In some embodiments, the molecular weight of the polymer fraction prepared in each of the reactors is set by addition of hydrogen to the reaction mixture. In some embodiments, the polymerization process is carried out with the highest hydrogen concentration and the lowest comonomer concentration, based on the amount of monomer, being set in the first reactor. In the subsequent further reactors, the hydrogen concentration is gradually reduced and the comonomer concentration is altered, based on the amount of monomer. In some embodiments, ethylene or propylene is used as monomer. In some embodiments, a 1-olefin having from 4 to 10 carbon atoms is used as comonomer.

In some embodiments, the suspension polymerization is carried out in loop reactors, where the polymerization mixture is pumped continuously through a cyclic reactor tube. The pumped circulation results in continual mixing of the reaction mixture and distribution of the catalyst and the monomers in the reaction mixture. Furthermore, the pumped circulation prevents sedimentation of the suspended polymer. The removal of the heat of reaction via the reactor wall is also promoted by the pumped circulation. In some embodiments, these reactors consist of a cyclic reactor tube having one or more ascending legs and one or more descending legs which are enclosed by cooling jackets for removal of the heat of reaction and also horizontal tube sections which connect the vertical legs. In some embodiments, the impeller pump, the catalyst feed facilities, the monomer feed facilities, and the discharge facility are installed in the lower tube section. In some embodiments, the discharge facility is the settling legs. In some embodiments, the reactor has more than two vertical tube sections, thereby obtaining a meandering arrangement.

In some embodiments, the suspension polymerization is carried out in the loop reactor at an ethylene concentration of at least 5 mole percent, alternatively 10 mole percent, based on the suspension medium. In this context, suspension medium refers to the mixture of the fed suspension medium with the monomers dissolved therein. In some embodiments, the ethylene concentration is determinable by gas-chromatographic analysis of the suspension medium.

In some embodiments, the polymerization process is carried out as gas-phase polymerization, that is, by a process wherein the solid polymers are obtained from a gas-phase of the monomer or the monomers. In some embodiments, the gas-phase polymerizations are carried out at pressures of from 0.1 MPa to 20 MPa, alternatively from 0.5 MPa to 10 MPa, alternatively from 1.0 MPa to 5 MPa. In some embodiments, the polymerization temperatures are from 40° C. to 150° C., alternatively from 65° C. to 125° C.

In some embodiments, the gas-phase polymerization reactors are horizontally or vertically stirred reactors, fluidized bed gas-phase reactors, or multizone circulating reactors, alternatively fluidized bed gas-phase reactors or multizone circulating reactors.

Fluidized-bed polymerization reactors are reactors, wherein the polymerization takes place in a bed of polymer particles maintained in a fluidized state by feeding in gas at the lower end of a reactor and taking off the gas again at the upper end of the reactor. In some embodiments, the gas is fed below a gas distribution grid, having the function of dispensing the gas flow. The reactor gas is then returned to the lower end of the reactor via a gas recycle line equipped with a compressor and a heat exchanger. In some embodiments, the circulated reactor gas is a mixture of the olefins to be polymerized, inert gases or lower alkanes, and optionally a molecular weight regulator. In some embodiments, the inert gas is nitrogen. In some embodiments, the lower alkanes are selected from the group consisting of ethane, propane, butane, pentane, and hexane. In some embodiments, the molecular weight regulator is hydrogen. In some embodiments, nitrogen or propane is used as inert gas. In some embodiment, nitrogen or propane is used in combination with lower alkanes. In some embodiments, the velocity of the reactor gas fluidizes the mixed bed of finely divided polymer present in the tube serving as polymerization zone and removes the heat of polymerization. In some embodiments, the polymerization is carried out in a condensed or super-condensed mode, wherein part of the circulating reaction gas is cooled to below the dew point and returned to the reactor (a) separately as a liquid and a gas or (b) together as a liquid-gas phase mixture, thereby making additional use of the enthalpy of vaporization for cooling the reaction gas.

Multizone circulating reactors are gas-phase reactors, wherein two polymerization zones are linked to each another and the polymer is passed alternately a plurality of times through these two zones. In some embodiments, the reactors are as described in Patent Cooperation Treaty Publication Nos. WO 97/04015 A1 and WO 00/02929 A1. In some embodiments, the reactors have two interconnected polymerization zones, a riser, wherein the growing polymer particles flow upward under fast fluidization or transport conditions and a downcomer, wherein the growing polymer particles flow in a densified form under the action of gravity. The polymer particles leaving the riser enter the downcomer, and the polymer particles leaving the downcomer are reintroduced into the riser, thereby establishing a circulation of polymer between the two polymerization zones. In some embodiments, the polymer is passed alternately a plurality of times through these two zones. In some embodiments, the two polymerization zones of a multizone circulating reactor are operated with different polymerization conditions by establishing different polymerization conditions in the riser and the downcomer. In some embodiments and for this purpose, the gas mixture leaving the riser and entraining the polymer particles is partially or totally prevented from entering the downcomer. In some embodiments, a barrier fluid in form of a gas or a liquid mixture is fed into the downcomer, alternatively in the upper part of the downcomer. In some embodiments, the composition of the barrier fluid differs from the composition of the gas mixture present in the riser. In some embodiments, the amount of added barrier fluid is adjusted such that an upward flow of gas countercurrent to the flow of the polymer particles is generated and acts as a barrier to the gas mixture entrained among the particles coming from the riser. In some embodiments, the countercurrent occurs at the top of the riser unit. In some embodiments, two different gas composition zones are obtained in one multizone circulating reactor. In some embodiments, make-up monomers, comonomers, molecular weight regulator, or inert fluids are introduced at any point of the downcomer, alternatively below the barrier feeding point. In some embodiments, the molecular weight regulator is hydrogen. In some embodiments, varying monomer, comonomer, or hydrogen concentrations are created along the downcomer, thereby further differentiating the polymerization conditions.

In some embodiments, the gas-phase polymerization processes are carried out in the presence of a C₃-C₅ alkane as polymerization diluent, alternatively in the presence of propane. In some embodiments, the gas-phase polymerization process is for the homopolymerization or copolymerization of ethylene.

In some embodiments, the polymerization reactors are different or identical polymerization reactors. In some embodiments, the polymerization reactors are connected in series, thereby forming a polymerization cascade. In some embodiments, the parallel arrangement of reactors uses two or more different or identical polymerization methods.

In some embodiments, the process for preparing an olefin polymer is carried out in a series of two or more gas-phase reactors. In some embodiments, the polymerization of olefins is carried out in a series including a fluidized-bed reactor and a multizone circulating reactor. In some embodiments, the fluidized-bed reactor is arranged upstream of the multizone circulating reactor. In some embodiments, a series of gas-phase reactors includes additional polymerization reactors. In some embodiments, the additional reactors are low-pressure polymerization reactors such as gas-phase reactors or suspension reactors. In some embodiments, the additional reactors include a pre-polymerization stage.

In some embodiments, a gaseous stream is withdrawn from the polymerization apparatus having a polymerization reactor or a combination of polymerization reactors. In some embodiments, the polymerization is a gas-phase polymerization, and the gaseous stream is withdrawn from any position within the polymerization apparatus. In some embodiments, the gaseous stream is withdrawn from a position within the polymerization apparatus at which reaction gas is present. In some embodiments, the gaseous stream is withdrawn directly from the reactor. In some embodiments and in polymerizations in a fluidized-bed reactor or in a multizone circulating reactor, the gaseous stream is withdrawn from the gas recycle line. In some embodiments, the polymerization is a suspension polymerization conducted in a polymerization reactor partially filled with suspension and the gaseous stream is withdrawn from a vapor section within the polymerization reactor above the level of suspension in the reactor. In some embodiments, the polymerization is carried out in a filled polymerization reactor such as a loop reactor, the gaseous stream is withdrawn from a piece of equipment of the polymerization apparatus, other than the reactor, where a gaseous phase is present. In some embodiments, the piece of equipment is a flash vessel installed downstream of a polymerization reactor or a piece of equipment connected to a flash vessel.

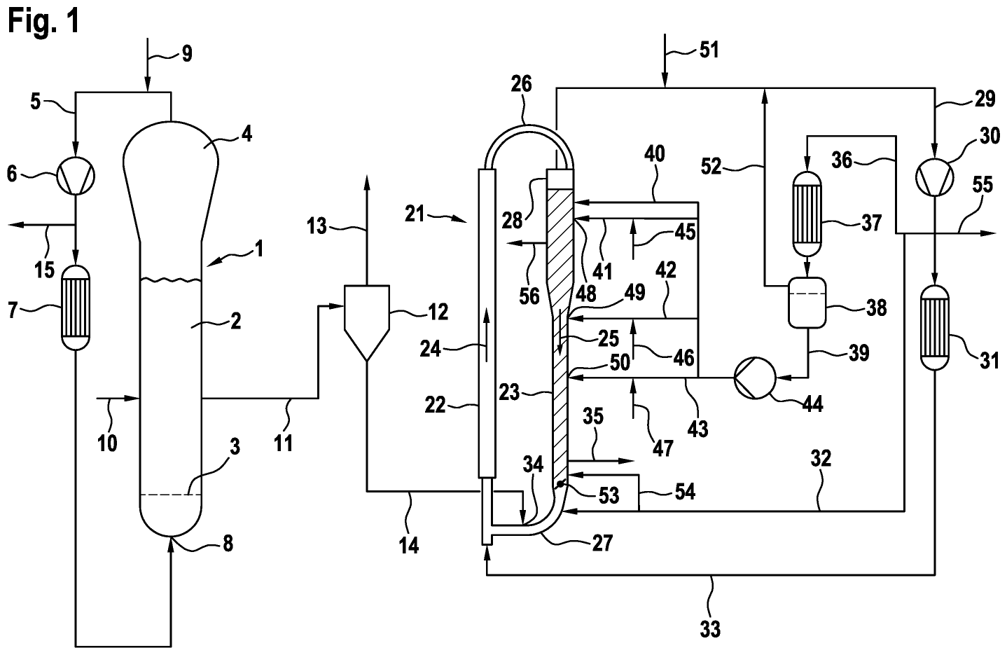

FIG. 1 shows a schematic of a polymerization apparatus including a series of polymerization reactors including a fluidized-bed reactor and a multizone circulating reactor.

The first gas-phase reactor, fluidized-bed reactor (1), includes a fluidized bed (2) of polyolefin particles, a gas distribution grid (3), and a velocity reduction zone (4). In some embodiments, the velocity reduction zone (4) is of increased diameter compared to the diameter of the fluidized-bed portion of the reactor. An upward flow of gas fed through the gas distribution grid (3), placed at the bottom portion of the reactor (1), keeps the polyolefin bed in a fluidized state. The gaseous stream of the reaction gas mixture leaving the top of the velocity reduction zone (4) via recycle line (5) is compressed by compressor (6), transferred to a heat exchanger (7), wherein the reaction gas is cooled, and then recycled to the bottom of the fluidized-bed reactor (1) at a point below the gas distribution grid (3) at position (8). In some embodiments, the recycle gas is cooled to below the dew point of one or more of the recycle gas components in the heat exchanger, thereby operating the reactor with condensed material or in the condensing mode. In some embodiments, the recycle gas is made from or containing unreacted monomers, inert condensable gases, and inert non-condensable gases. In some embodiments, the inert condensable gases are alkanes. In some embodiments, the inert non-condensable gas is nitrogen. In some embodiments, make-up monomers, hydrogen, optional inert gases, or process additives are fed into the reactor (1) at various positions, alternatively via line (9) upstream of the compressor (6). In some embodiments, the catalyst is fed into the reactor (1) via a line (10). In some embodiments, line (1)) is placed in the lower part of the fluidized bed (2).

The polyolefin particles obtained in fluidized-bed reactor (1) are discontinuously discharged via line (11) and fed to a solid/gas separator (12), thereby preventing entry of the gaseous mixture, coming from the fluidized-bed reactor (1), into the second gas-phase reactor. The gas leaving solid/gas separator (12) exits the reactor via line (13) as off-gas while the separated polyolefin particles are fed via line (14) to the second gas-phase reactor.

For analyzing the composition of the reaction gas within the fluidized-bed reactor (1), a gas stream is withdrawn from the recycle line (5) at a position between the compressor (6) and the heat exchanger (7) through sampling line (15).

The second gas-phase reactor is a multizone circulating reactor (21), including a riser (22) and a downcomer (23) which are repeatedly passed by the polyolefin particles. Within riser (22), the polyolefin particles flow upward under fast fluidization conditions along the direction of arrow (24). Within the downcomer (23) and under the action of gravity, the polyolefin particles flow downward along the direction of the arrow (25). The riser (22) and the downcomer (23) are interconnected by the interconnection bends (26) and (27).

After flowing through the riser (22), the polyolefin particles and the reaction gas mixture leave riser (22) and are conveyed to a solid/gas separation zone (28). In some embodiments, solid/gas separation is effected by a centrifugal separator like a cyclone. From the separation zone (28), the polyolefin particles enter downcomer (23).

The reaction gas mixture leaving the separation zone (28) is recycled to the riser (22) via a recycle line (29), equipped with a compressor (30) and a heat exchanger (31). Between the compressor (30) and the heat exchanger (31), recycle line (29) splits. Accordingly, the gaseous mixture is divided into two streams: line (32) conveys a first part of the recycle gas into the interconnection bend (27) while line (33) conveys a second part of the recycle gas to the bottom of riser (22), thereby establishing fast fluidization conditions therein.

The polyolefin particles coming from the first gas-phase reactor via line (14) enter the multizone circulating reactor (21) at the interconnection bend (27) in position (34). The polyolefin particles obtained in multizone circulating reactor (21) are continuously discharged from the bottom part of downcomer (23) via the discharge line (35).

A first part of the gaseous mixture leaving the separation zone (28) exits the recycle line (29) after having passed the compressor (30) and is sent through line (36) to the heat exchanger (37), where the first part is cooled to a temperature at which the monomers and the optional inert gas are partially condensed. A separating vessel (38) is placed downstream of the heat exchanger (37). The separated liquid is withdrawn from the separating vessel (38) via line (39) and fed to downcomer (23) through lines (40), (41), (42) and (43) by a pump (44), wherein the feed stream introduced via line (40) is supplied to generate the barrier for preventing the reaction gas mixture of the riser (22) from entering the downcomer (23). In some embodiments, a combination of make-up monomers, make-up comonomers, optionally inert gases, or process additives are introduced via lines (45), (46) and (47) into lines (41), (42) and (43) and then fed into the downcomer (23) at monomer feeding points (48), (49) and (50). In some embodiments, a combination of make-up monomers, make-up comonomers, optionally inert gases, or process additives are introduced into the recycle line (29) via line (51). The gaseous mixture obtained as gas-phase in the separating vessel (38) is recirculated to recycle line (29) through line (52).

The bottom of the downcomer (23) is equipped with a control valve (53) having an adjustable opening for adjusting the flow of polyolefin particles from downcomer (23) through the interconnection bend (27) into the riser (22). Above the control valve (53), amounts of a recycle gas mixture coming from the recycle line (29) through lines (32) and (54) are introduced into the downcomer (23), thereby facilitating the flow of the polyolefin particles through the control valve (53).

For analyzing the composition of the reaction gas within riser (22) and the downcomer (23), gas streams are withdrawn from the recycle line (29) at a position between the compressor (30) and the heat exchanger (31) through sampling line (55) and from the downcomer (23) through sampling line (56).

In some embodiments, the gaseous stream withdrawn from the polymerization apparatus is fed to an analyzer. In some embodiments, the analyzer is a gas chromatograph, a Raman probe, an IR detector, a mass spectrometer, or a thermal conductivity detector. In some embodiments, the analyzer is a gas chromatograph.

Before being introduced into the analyzer, the gaseous stream is passed through a bed of particulate solid having at the surface chemical groups which are reactive with the organometallic compound.

In some embodiments, the particulate solid, having at the surface chemical groups which are reactive with the organometallic compound, is a porous material. In some embodiments, the porous material is selected from the group consisting of talc, a sheet silicate, and an inorganic oxide.

In some embodiments, the inorganic oxides are selected from the group consisting of oxides of the elements of groups 2, 3, 4, 5, 13, 14, 15 and 16 of the Periodic Table of the Elements. In some embodiments, the inorganic oxides are selected from the group consisting of oxides or mixed oxides of the elements calcium, aluminum, silicon, magnesium, or titanium. In some embodiments, the inorganic oxides are ZrO₂ or B₂O₃. In some embodiments, the oxides are silicon dioxide, aluminum oxide, or silicon aluminum mixed oxides. In some embodiments, the silica oxides are in the form of a silica gel or a pyrogenic silica. In some embodiments, the mixed oxide is calcined hydrotalcite. In some embodiment, the silica has the formula SiO₂·a Al₂O₃, where a is from 0 to 2, alternatively from 0 to 0.5. In some embodiments, the particles of the particulate solid are in granular form. In some embodiments, the particles of the particulate solid are in spray-dried form, wherein the particles of the particulate solid have a mean particle diameter of from 5 nm to 5 μm.

In some embodiments, the particulate solid, having at the surface chemical groups which are reactive with the organometallic compound, is built of particles having a mean particle diameter in the range from 50 μm to 10 mm, alternatively from 200 μm to 5 mm In some embodiments, the particulate solid has a specific surface area in the range from 200 m²/g to 1000 m²/g, alternatively from 500 m²/g to 800 m²/g, determined by gas adsorption according to the BET method as specified in ISO 9277:2010.

In some embodiments, the chemical groups at the surface of the particulate solid which are reactive with the organometallic compound are OH groups, adsorbed water, or strained Si—O—Si bridges. In some embodiments, the particulate solids are calcinated solids and the chemical groups at the surface of the particulate solid which are reactive with the organometallic compound are strained Si—O—Si bridges.

By reacting with the organometallic compound, the reactive chemical groups at the surface of the particulate solid are consumed. Accordingly, the zone within the bed of particulate solid in which a reaction of the organometallic compound with the reactive surface groups occurs moves through the bed of particulate solid. In some embodiments, the bed of particulate solid is replaced by a fresh bed of particulate solid before the entirety of the reactive surface groups have reacted with the organometallic compound.

In some embodiments, the particulate solid is a silica gel which is equipped with a humidity indicator. In some embodiments, the organometallic compound reacts with the colored humidity indicator and changes the color of the silica gel particles, thereby allowing for monitoring of the consumption of the reactive surface groups.

In some embodiments, the gaseous stream withdrawn from the polymerization apparatus is a continuous gas stream withdrawn at a flow rate of from 1 Nl/h to 5000 Nl/h, alternatively from 1 Nl/h to 500 Nl/h, alternatively from 5 Nl/h to 350 Nl/h, alternatively from 10 Nl/h to 250 Nl/h. As used herein, the unit “Nl” refers to a norm liter, which is the amount of a gas having a volume of one liter at the norm conditions of 101 325 Pa (=1.01325 bar) and 0° C.

In some embodiments, the analyzer is provided with the sample of the gaseous stream at intervals.

In some embodiments, two or more, alternatively two, three, four, or five, gaseous streams are withdrawn from the polymerization apparatus at different positions. In some embodiments, samples of one or more the gaseous streams are fed subsequently to an analyzer for analyzing the sample. In some embodiments, one or more of the gaseous streams have a dedicated analyzer.

For analyzing a material composition, a gaseous stream is withdrawn from the polymerization apparatus. In some embodiments, the gaseous stream is conveyed into a sampling loop which is located close to, alternatively within, the analyzer such as the gas chromatograph. The sampling loop provides a defined volume of a gaseous sample which is then transferred into the analyzing unit. In some embodiments, the gaseous sample is transferred by an inert carrier gas. In some embodiments, the analyzer is calibrated, such that the sum of the measured components is 100%.

Passing the gaseous stream withdrawn from the polymerization apparatus through a bed of particulate solid having at the surface chemical groups which are reactive with the organometallic compound avoids the accumulation of fine solid particles within the sampling device of the analyzer and the measured sum of the components remains stable. In some embodiments, by passing the gaseous stream through a bed of particulate solid having at the surface chemical groups which are reactive with the organometallic compound, the concentration of the organometallic compound in the gas stream exiting the bed of particulate solid is less than 99%, alternatively less than 99.5%, alternatively less than 99.8%, alternatively less than 99.9%, of the concentration of the organometallic compound in the gaseous stream withdrawn from the polymerization apparatus.

In some embodiments, the bed of particulate solid is contained in a vessel having a volume of from 50 cm³ to 10 000 cm³, alternatively from 100 cm³ to 5000 cm³, alternatively from 200 cm³ to 2500 cm³.

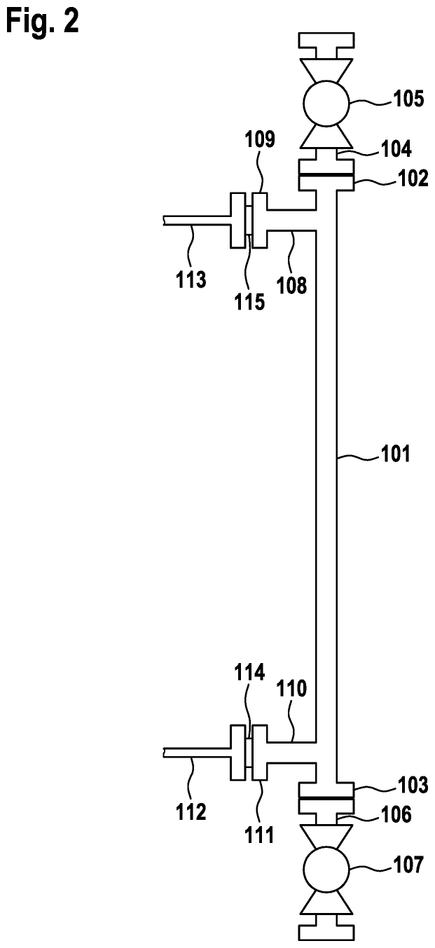

FIG. 2 shows a schematic of a vessel for containing a bed of particulate solid.

The vessel has a vertical tube (101) having on top and at the bottom flanges (102) and (103). Attached to flange (102) is a first short tube element (104) having a ball valve (105) for filling tube (101) with the bed of particulate solid. Attached to flange (103) is a second short tube element (106) having a ball valve (107) for emptying tube (101).

Vertical tube (101) is equipped with a short horizontal tube (108) ending with a flange (109) close to the upper end of tube (101) and is equipped with a short horizontal tube (110) ending with a flange (111) close to the lower end of tube (101). A thinner tube (112) for feeding a gas stream into tube (101) is attached to flange (111). A thinner tube (113) is attached to flange (109) for withdrawing the gas stream from tube (101) after having passed tube (101). For retaining the bed of particulate solid within tube (101), the connection between flange (111) and tube (112) and the connection between flange (109) and tube (113) are equipped with screens (114) and (115) made of steel.

In some embodiments, the bed of particulate solid is contained in a vessel having a pipe having a diameter from 6 mm to 100 mm, alternatively from 10 mm to 80 mm, alternatively from 15 mm to 50 mm, which has an inlet for introducing a gas stream into the pipe and an outlet for withdrawing a gas stream from the pipe, wherein the distance between the inlet and the outlet is from 0.2 m to 10 m, alternatively from 0.3 m to 5 m, alternatively from 0.4 m to 2 m.

In some embodiments, the vessel further has a first valve at a first end of the pipe for introducing the bed of particulate solid into the pipe and a second valve at the opposing, second end of the pipe for removing the bed of particulate solid from the pipe. In some embodiments, the inlet and the outlet of the pipe are provided with screens having a mesh size from 35 μm to 2 mm, alternatively from 50 μm to 1.5 mm, alternatively from 100 μm to 1 mm, for retaining the bed of particulate solid within the pipe. In some embodiments, the vessel has a first and a second valve at the ends of the pipe and the inlet and the outlet of the pipe are provided with screens.

In some embodiments, the present disclosure provides a vessel having a pipe having a diameter from 6 mm to 100 mm, alternatively from 10 mm to 80 mm, alternatively from 15 mm to 50 mm, an inlet for introducing a gas stream into the pipe, an outlet for withdrawing a gas stream from the pipe, a first valve at a first end of the pipe for introducing a bed of particulate solid into the pipe and a second valve at the opposing, second end of the pipe for removing the bed of particulate solid from the pipe, wherein the inlet and the outlet of the pipe are provided with screens having a mesh size from 35 μm to 2 mm, alternatively from 50 μm to 1.5 mm, alternatively from 100 μm to 1 mm, and the distance between the inlet and the outlet is from 0.2 m to 10 m, alternatively from 0.3 m to 5 m, alternatively from 0.4 m to 2 m.

In some embodiments, the results obtained by the analysis of the gaseous samples are fed as measurement signals to a controller for controlling the process for preparing the olefin polymer.

In some embodiments, the present disclosure provides a method for controlling an olefin polymerization process for homopolymerizing an olefin or copolymerizing an olefin and one or more other olefins at temperatures from 20 to 200° C. and pressures of from 0.1 MPa to 20 MPa, in the presence of a solid particulate polymerization catalyst and an organometallic compound in a polymerization apparatus including a polymerization reactor or a combination of polymerization reactors, including the steps of
withdrawing a gaseous stream from the polymerization apparatus;
passing the gaseous stream through a bed of particulate solid having, at the surface of the particulate solid, chemical groups which are reactive with the organometallic compound;
feeding a sample of the gaseous stream into an analyzer for analyzing the gaseous sample;
analyzing the sample, thereby obtaining information on the conditions within the polymerization apparatus; and
adapting, based on the information, the polymerization conditions within the polymerization apparatus to predefined values.

In some embodiments, the present disclosure provides a process for preparing an olefin polymer including a method for controlling the olefin polymerization process.

In some embodiments, the information is used to define polymerization conditions for certain grades or conditions. In some embodiments, the information is used to adapt the measured polymerization conditions to predefined values. In some embodiments, the adaptations are carried out manually by an operator or automated. In some embodiments, the information is fed as a measurement signals to a controller for controlling the olefin polymerization process.

### EXAMPLES

### Comparative Example A

In a series of a fluidized-bed reactor and a multizone circulating reactor (MZCR) having two interconnected reaction zones as shown in FIG. 1, a number of grades of ethylene 1-hexene copolymer, having 1-hexene content in the range from 0 wt. % to 4 wt. %, were produced with an average output of 100 kg/h at temperature in the range from 60° C. to 110° C. and pressures from 1 MPa to 10 MPa. The catalyst system for carrying out the polymerizations was a Ziegler-Natta catalyst system made from or containing a catalyst solid prepared by supporting TiCl₄ on a MgCl₂ carrier. Triisobutylaluminum was employed as a cocatalyst and fed to the polymerizations at feeding rates in the range from 25 g/h to 50 g/h.

The polymerizations were controlled by measuring the gas compositions in the fluidized-bed reactor (1) and in the riser (22) and the downcomer (23) of the multizone circulating reactor (21), by withdrawing reaction gas through sampling lines (15), (55) and (56) and transferring the gases to a MAXUM Edition II gas chromatograph (Siemens AG, Nümberg, Germany; not shown in FIG. 1). The gas chromatograph was alternately supplied with reaction gas via lines (15), (55), and (56). After selecting the polymerization zone for determining the reaction gas composition and the sampling line, reaction gas was continuously withdrawn through one of sampling lines (15), (55), and (56), passed first through an in-line 15 μm particulate filter (Swagelok Company, Solon, Ohio, USA) for protecting the gas chromatograph from fine particles, and thereafter passed through a pressure reducer which reduced the pressure to 0.17 MPa (abs). The flow rates of the reaction gases, measured after the pressure reducer at 0.17 MPa, was 30 Nl/h for the selected sampling lines (15), (55), and (56). In spatial proximity to the gas chromatograph, a side stream, having a flow rate of 5 Nl/h, was branched off and fed to a sample valve having an injection loop. The remainder of the reaction gas withdrawn through lines (15), (55) and (56) was conveyed to off-gas. Sampling lines (15), (55), and (56) were operated with a flow-rate of reaction gas higher than the flow-rate of the gas fed into the sample valve, thereby reducing the dead time between withdrawing a gas from the polymerization apparatus and introducing the gas into the gas chromatograph.

For carrying out the measurement, the position of the sample valve was switched and the injection loop, which was previously passed by the reaction gas to be analyzed, was integrated into a carrier gas line and the content of the injection loop was then transferred into the gas chromatograph by the carrier gas. For taking a next GC chromatogram, the sample valve was switched back into a position in which the injection loop was passed again with reaction gas to be analyzed. The flushing of the injection loop with reaction gas was continued for at least 1 minutes before the injection loop with was again integrated into the carrier gas stream. In average, the gas chromatograph was operated at a rate of recording 20 gas chromatographs per hour.

Regularly, the sum of the measured components decreased, thereby leading to cleaning of injection loop and sample valve. After such a cleaning operation, the gas chromatograph was calibrated so that the sum of the measured components was 100%. This value was not stable. The sum of measured components continuously decreased. After two weeks, the sum of measured components was below 80%, drastically lowering the accuracy of the GC measurement. By recalibrating the gas chromatograph, the sum of the measured components was reset to 100% and the gas chromatograph was used with accuracy for another 10 days until the sum of the measured components went again below 80%. The gas chromatograph was recalibrated. One week thereafter, the sum of measured components was again below 80%. To avoid a further shortening of the time period with an acceptable accuracy of the GC measurement, the polymerization was terminated, the gas chromatograph was dismantled, and the injection loop and sample valve were cleaned. Thereafter, the polymerization was resumed, resulting, in average, in an interruption of the polymerization for two days.

### Example 1

The sequence of polymerizations carried out in Comparative Example A was continued under, in average, the same conditions. A vessel containing a bed of silica as shown in FIG. 2 was installed in the sampling line between the pressure reducer and the position, where the side stream to the sample valve of the gas chromatograph was branched off. The vessel included a tube (101), having an inner diameter of 25 mm and a length of 850 mm, from flange (102) to flange (103). The vessel was filled with a silica equipped with a humidity indicator (Silica Gel Orange, 2-5 mm, with indicator, pearls, Carl Roth GmbH+Co. KG, Karlsruhe, German). Screens (114) and (115) were 20 mesh screens (mesh size 850 μm).

Polymerizations were carried out for 4 weeks. The sum of measured components remained at more than 99% for the period. After 4 weeks, polymerization was interrupted. The vessel (101) was emptied. About a quarter of the silica had changed color from orange to dark brown.

### Example 2

Example 1 was repeated with fresh silica. The polymerizations were carried out for 3 months. The sum of measured components decreased to 95%. Thereafter, the silica bed was removed from vessel (101). A smaller part of the silica had not turned from orange to dark brown.

### Example 3

Example 2 was repeated. A different silica equipped with humidity indicator was used (Silica Gel Orange, granular, 0.2-1 mm, Sigma-Aldrich, Merck KGaA, Darmstadt, Germany). Screens (114) and (115) were 100 mesh screens (mesh size 150 μm).

The sum of measured components decreased to 96%. The vessel (101) was emptied after 3 months and showed that that the greater portion of the silica had turned dark brown while part remained orange.

1. A process for preparing an olefin polymer comprising the steps of:
a) feeding
(i) a solid particulate polymerization catalyst,
(ii) an organometallic compound, and
(iii) an olefin or a combination of an olefin and one or more other olefins
into a polymerization apparatus comprising a polymerization reactor or a combination of polymerization reactors,
b) homopolymerizing the olefin or copolymerizing the olefin and the one or more other olefins at temperatures from 20° C. to 200° C. and pressures of from 0.1 MPa to 20 MPa, in the presence of the polymerization catalyst and the organometallic compound,
c) withdrawing a gaseous stream from the polymerization apparatus,
d) passing the gaseous stream through a bed of particulate solid, having, at the surface of the particulate solid, chemical groups which are reactive with the organometallic compound, and
e) feeding a sample of the gaseous stream into an analyzer for analyzing the gaseous sample.

2. The process of claim 1, wherein the analyzer is a gas chromatograph.

3. The process of claim 1, wherein the organometallic compound is an aluminum alkyl.

4. The process of claim 1, wherein the particulate solid is an oxide or a mixed oxide of an element selected from the group consisting of calcium, aluminum, silicon, magnesium, and titanium.

5. The process of claim 1, wherein the chemical groups, at the surface of the particulate solid which are reactive with the organometallic compound, are selected from the group consisting of OH groups, adsorbed water, and strained Si—O—Si bridges.

6. The process of claim 1, wherein the particulate solid is a silica gel equipped with a humidity indicator.

7. The process of claim 1, wherein the gaseous stream withdrawn from the polymerization apparatus is a continuous gas stream which is withdrawn from the polymerization apparatus at a flow rate of from 1 Nl/h to 5000 Nl/h.

8. The process of claim 1, wherein the analyzer is provided with the sample of the gaseous stream at intervals.

9. The process of claim 1, wherein two or more gaseous streams are withdrawn from the polymerization apparatus at different positions.

10. The process of claim 1, wherein the bed of particulate solid is contained in a vessel having a volume of from 50 cm³ to 10 000 cm³.

11. The process of claim 10, wherein the bed of particulate solid is contained in a vessel comprising a pipe having a diameter from 6 mm to 100 mm, an inlet for introducing a gas stream into the pipe, and an outlet for withdrawing a gas stream from the pipe, wherein the distance between the inlet and the outlet is from 0.2 m to 10 m.

12. The process of claim 10, wherein the vessel further comprises a first valve at a first end of the pipe for introducing the bed of particulate solid into the pipe and a second valve at the opposing, second end of the pipe for removing the bed of particulate solid from the pipe.

13. The process of claim 1, wherein the results obtained by the analysis of the gaseous samples are fed as measurement signals to a controller for controlling the process for preparing the olefin polymer.

14. A vessel comprising:
(a) a pipe having a diameter from 6 mm to 100 mm,
(b) an inlet for introducing a gas stream into the pipe,
(c) an outlet for withdrawing a gas stream from the pipe,
(d) a first valve at a first end of the pipe for introducing a bed of particulate solid into the pipe, and
(e) a second valve at the opposing, second end of the pipe for removing the bed of particulate solid from the pipe,
wherein the inlet and the outlet of the pipe are provided with screens having a mesh size from 35 μm to 2 mm for retaining the bed of particulate solid within the pipe and the distance between the inlet and the outlet is from 0.2 m to 10 m.

15. A method for controlling an olefin polymerization process comprising homopolymerizing an olefin or copolymerizing an olefin and one or more other olefins at temperatures from 20 to 200° C. and pressures of from 0.1 MPa to 20 MPa, in the presence of a solid particulate polymerization catalyst and an organometallic compound in a polymerization apparatus comprising a polymerization reactor or a combination of polymerization reactors, comprising the steps of:
withdrawing a gaseous stream from the polymerization apparatus;
passing the gaseous stream through a bed of particulate solid having, at the surface of the particulate solid, chemical groups which are reactive with the organometallic compound;
feeding a sample of the gaseous stream into an analyzer for analyzing the gaseous sample;
analyzing the sample, thereby obtaining information on the conditions within the polymerization apparatus; and
adapting, based on the information, the polymerization conditions within the polymerization apparatus to predefined values.
